(19) United States
(12) Patent Application Publication
(10) Pub. No.: US 2024/0176223 A1
(43) Pub. Date: May 30, 2024

(54) CAMERA MODULE

(71) Applicant: Sharp Sensing Technology Corporation, Tenri City (JP)

(72) Inventors: Haruno YOSHIDA, Tenri City (JP); Yoshihito ISHIZUE, Tenri City (JP)

(21) Appl. No.: 18/504,804

(22) Filed: Nov. 8, 2023

(30) Foreign Application Priority Data
Nov. 30, 2022 (JP) 2022-192371

(51) Int. Cl. G03B 30/00; G02B 7/02

(52) U.S. Cl. CPC G03B 30/00; G02B 7/021

(57) ABSTRACT

A camera module has a first lens group, a first lens block that holds the first lens group and has a first face, a second lens group, a second lens block that holds the second lens group and has a drive mechanism that drives the second lens group in the optical axis direction. The second lens block has a second face opposite the first face. A first hole is formed in one of the first face and the second face, and a first shaft that is fitted into the first hole is formed in the other of the first face and the second face.

### BACKGROUND

### 1. Field

The present disclosure relates to a camera module. This application claims priority based on Japanese Patent Application No. 2022-192371 filed in Japan on Nov. 30, 2022, the contents of which are hereby incorporated herein by reference.

### 2. Description of the Related Art

Japanese Unexamined Patent Application Publication No. 2009-271405 relates to a camera module.

In the camera module, a plurality of positioning recesses are provided at the four corners of the sensor substrate. In addition, a plurality of positioning protrusions are provided at the four corners of the base member. The plurality of positioning protrusions are provided at positions corresponding to the plurality of positioning recesses. The combinations of the plurality of positioning recesses and the plurality of positioning protrusions act as positioning members for positioning the sensor substrate and the base member (see paragraphs 0036 and 0058).

When the positioning members provided in the camera module disclosed in Japanese Unexamined Patent Application Publication No. 2009-271405 are used to position a lens block holding a lens group and an actuator block holding a lens group and driving the lens group in an optical axis direction relative to each other, there are cases in which it is difficult to align an optical center of the lens group in the lens block and an optical center of the lens group in the actuator block with each other with high accuracy.

In view of the above, an aspect of the present disclosure is to provide a camera module that can, for example, align an optical center of a first lens group held in a first lens block and an optical center of a second lens group held and driven in a second lens block with each other with high accuracy.

### SUMMARY

A camera module of an aspect of the present disclosure has a first lens group that transmits light, a first lens block that holds the first lens group and has a first face, a second lens group that transmits the light, and a second lens block that holds the second lens group, has a drive mechanism to drive the second lens group in an optical axis direction, and has a second face opposite the first face. A first hole having a first inner peripheral surface having a circumferential shape is formed in one of the first face and the second face. The first inner peripheral surface has a central axis that coincides with an optical center of the first lens group when the first hole is formed in the first face, and has a central axis that coincides with an optical center of the second lens group when the first hole is formed in the second face, and a first shaft having a first outer peripheral surface having a circumferential shape and being fitted into the first hole is formed in the other of the first face and the second face. The first outer peripheral surface has a central axis that coincides with the optical center of the second lens group when the first shaft is formed in the second face, and has a central axis that coincides with the optical center of the first lens group when the first shaft is formed in the first face.

### BRIEF DESCRIPTION OF THE DRAWINGS

FIG. 1 is a perspective view schematically illustrating a camera module according to a first embodiment;

FIG. 2 is a sectional view schematically illustrating a cross-section of the camera module of the first embodiment at a position on line A-A depicted in FIG. 1;

FIG. 3 is a block diagram of elements for focusing provided in the camera module of the first embodiment;

FIG. 4 is a sectional view schematically illustrating a cross-section of the camera module of the first embodiment at the position on line B-B depicted in FIG. 1;

FIG. 5 is a perspective view schematically illustrating a pair of a first lens block and a second lens block, a pair of a second lens block and an imaging block, or a pair of a reflection block and a first lens block provided in the camera module of the first embodiment;

FIG. 6 is a sectional view schematically illustrating a cross-section of a camera module according to a second embodiment;

FIG. 7 is a sectional view schematically illustrating a cross-section of a camera module according to a third embodiment; and

FIG. 8 is a sectional view of the camera module according to the third embodiment schematically illustrating a cross-section of the camera module in the vicinity of the protrusion and recess provided in the camera module.

### DESCRIPTION OF THE EMBODIMENTS

The embodiments of the present disclosure are described below with reference to the drawings. In the drawings, identical or equivalent elements are denoted by the same symbols, and redundant explanations are omitted.

### 1 First Embodiment

### 1.1 Camera Module

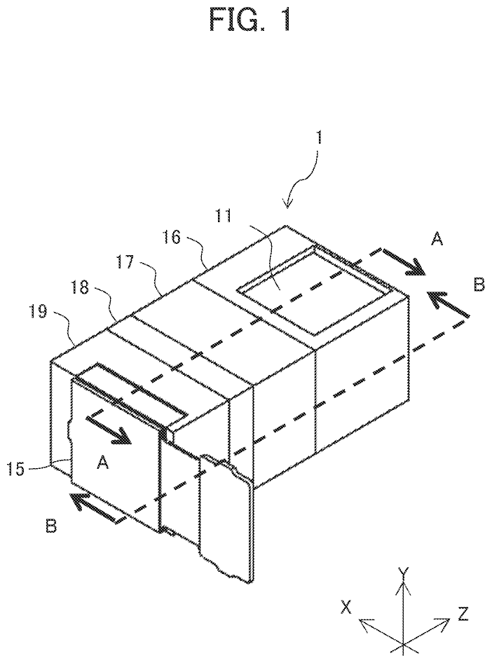

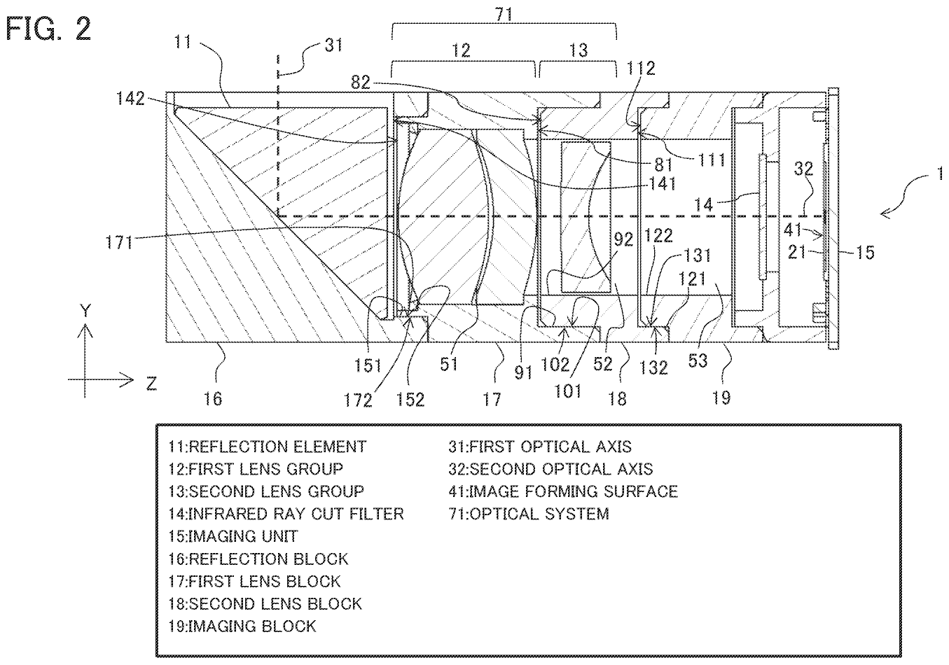

FIG. 1 is a perspective view of a camera module according to a first embodiment. FIG. 2 is a sectional view schematically illustrating a cross-section of the camera module according to the first embodiment at a position on line A-A depicted in FIG. 1. FIG. 2 illustrates a cross-section obtained by cutting the central portion of the camera module of the first embodiment in the direction of the optical axis of the camera module.

The camera module 1 of the first embodiment illustrated in FIGS. 1 and 2 receives light emitted by an object and outputs an electrical signal corresponding to the received light.

As illustrated in FIGS. 1 and 2, the camera module 1 includes a reflection element 11, a first lens group 12, a second lens group 13, an infrared ray cut filter 14, an imaging unit 15, a reflection block 16, a first lens block 17, a second lens block 18, and an imaging block 19. The imaging unit 15 includes an imaging element 21.

The reflection element 11 reflects light emitted from an object and traveling along a first optical axis 31 and causes the reflected light to travel along a second optical axis 32. The reflection element 11 is a prism. The reflection element 11 may be a reflection element other than a prism. For example, the reflection element 11 may be a mirror.

The first lens group 12 and the second lens group 13 transmit light traveling along the second optical axis 32. The first lens group 12 and the second lens group 13 converge the transmitted light onto an image forming surface 41. Accordingly, the first lens group 12 and the second lens group 13 form an image of the light onto the image forming surface 41.

The first lens group 12 receives light traveling along the second optical axis 32 and transmits the received light. The first lens group 12 includes one or more lenses. The first lens group 12 has a positive power as a whole.

The second lens group 13 is disposed at the rear of the first lens group 12. The second lens group 13 receives light transmitted through the first lens group 12, transmits the received light, and converges the transmitted light. The second lens group 13 includes one or more lenses. The second lens group 13 has a negative power as a whole.

The infrared ray cut filter 14 cuts the infrared component from the light transmitted through the first lens group 12 and the second lens group 13. As a result, the infrared ray cut filter 14 cuts the infrared component from the light converged on the image forming surface 41. The infrared ray cut filter 14 is disposed in front of the image forming surface 41. This reduces occurrence of foreign matter such as dust directly adhering to the image forming surface 41, thus reducing occurrence of light converged on the image forming surface 41 being blocked by foreign matter. As a result, it is possible to suppress deterioration of the image represented by the electrical signal output from the camera module 1 due to foreign matter.

The imaging element 21 has the image forming surface 41. The imaging element 21 photoelectrically converts light forming an image on the image forming surface 41 into an electrical signal. As a result, the imaging element 21 captures an image of the object formed by the light. The electrical signal generated by the conversion is processed by software and converted into an image. The imaging element 21 is a complementary metal oxide semiconductor (CMOS) image sensor, a charge coupled device (CCD) image sensor, or the like.

The reflection block 16 holds the reflection element 11.

The first lens block 17 holds the first lens group 12. The first lens block 17 holds the first lens group 12 by holding the outer circumference of the first lens group 12. The first lens block 17 has a cylindrical shape. Therefore, a first space 51 having a cylindrical shape is formed in the first lens block 17. The first space 51 accommodates the first lens group 12. The first space 51 is formed along the second optical axis 32 and penetrates the first lens block 17. Thus, the first space 51 allows light traveling along the second optical axis 32 to pass through and causes the passing-through light to be transmitted through the first lens group 12. The first lens block 17 is also referred to as a lens barrel.

The second lens block 18 holds the second lens group 13. The second lens block 18 holds the second lens group 13 by holding the outer circumference of the second lens group 13. The second lens block 18 has a cylindrical shape. Therefore, a second space 52 having a cylindrical shape is formed in the second lens block 18. The second space 52 accommodates the second lens group 13. The second space 52 is formed along the second optical axis 32 and penetrates the second lens block 18. Thus, the second space 52 allows light traveling along the second optical axis 32 to pass through and causes the passing-through light to be transmitted through the second lens group 13. The second lens block 18 is also referred to as a lens barrel.

The imaging block 19 holds the imaging element 21 by holding the imaging unit 15. The imaging block 19 also holds the infrared ray cut filter 14. The imaging block 19 has a cylindrical shape. Therefore, a third space 53 having a cylindrical shape is formed in the imaging block 19. The third space 53 is formed along the second optical axis 32. Therefore, the third space 53 allows light traveling along the second optical axis 32 to pass through the infrared ray cut filter 14 and reach the imaging element 21.

### 1.2 Focusing

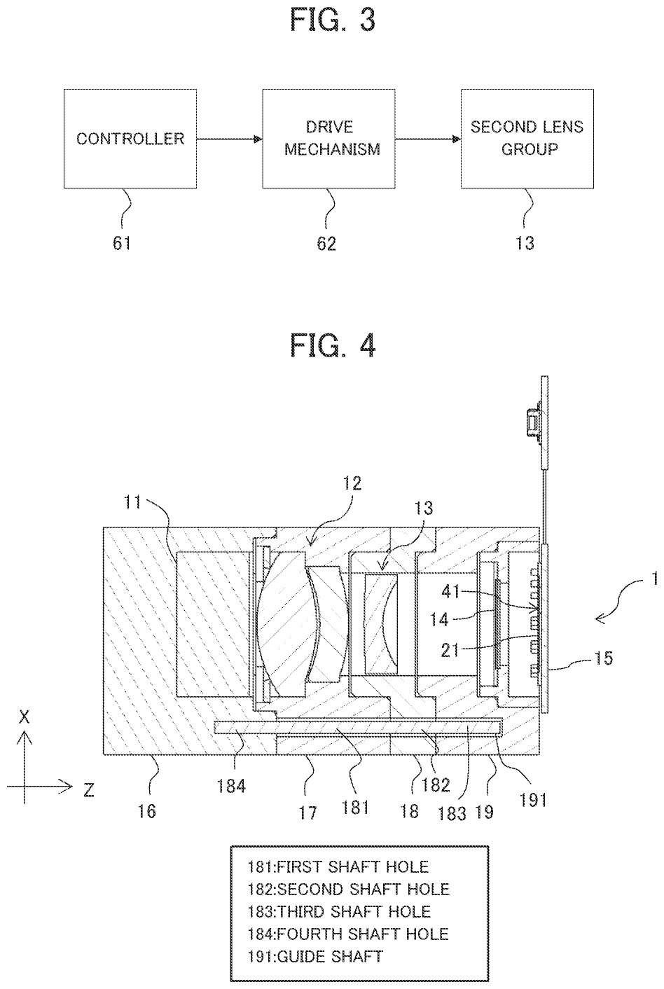

FIG. 3 is a block diagram of the elements for focusing provided in the camera module according to the first embodiment.

As illustrated in FIG. 3, the camera module 1 includes a controller 61 and a drive mechanism 62.

The controller 61 outputs control signals.

The drive mechanism 62 drives the second lens group 13 in a Z-axis direction (optical axis direction), which is parallel to the second optical axis 32 in response to the output control signal. This enables focusing on an object. The drive mechanism 62 is also called an actuator. The drive mechanism 62 is provided in the second lens block 18. Therefore, the second lens block 18 is also called an actuator block.

The first lens group 12 and the second lens block 18 including the second lens group 13 and the drive mechanism 62 constitute an optical system 71 that forms a light image on the image formation surface 41. The optical system 71 forms an image of the light through the optical system 71 onto the image forming surface 41.

### 1.3 Positioning of First Lens Block and Second Lens Block in X-Axis, Y-Axis, and Z-Axis Directions

As illustrated in FIG. 2, the first lens block 17 and the second lens block 18 have a first face 81 and a second face 82, respectively, facing each other.

A rear-end side opening, which is the rear end of the first space 51, is formed in the center of the first face 81. A front-end side opening, which is the front end of the second space 52, is formed in the center of the second face 82. The rear-end side opening and the front-end side opening have a circular circumferential shape.

A first hole 91 is formed in one of the first face 81 and the second face 82. A first shaft 92 is formed in the other of the first face 81 and the second face 82. FIG. 2 illustrates the first hole 91 formed in the first face 81 and the first shaft 92 formed in the second face 82.

The first hole 91 has a first inner peripheral surface 101. The first inner peripheral surface 101 has a circumferential shape. The first inner peripheral surface 101 has a central axis that coincides with an optical center of the first lens group 12 when the first hole 91 is formed in the first face 81. On the other hand, the first inner peripheral surface 101 has a central axis that coincides with an optical center of the second lens group 13 when the first hole 91 is formed in the second face 82. The first hole 91 is part of the first space 51 when the first hole 91 is formed in the first face 81. On the other hand, the first hole 91 is part of the second space 52 when the first hole 91 is formed in the second face 82.

The first shaft 92 has a first outer peripheral surface 102. The first outer peripheral surface 102 has a circumferential shape. The first outer peripheral surface 102 has a central axis that coincides with the optical center of the second lens group 13 when the first shaft 92 is formed in the second face 82. On the other hand, the first outer peripheral surface 102 has a central axis that coincides with the optical center of the first lens group 12 when the first shaft 92 is formed in the first face 81. The first shaft 92 surrounds a portion of the second space 52 externally in the radial direction when the first shaft 92 is formed in the second face 82. On the other hand, the first shaft 92 surrounds a portion of the first space 51 externally in the radial direction when the first shaft 92 is formed in the first face 81.

The first shaft 92 is inserted into the first hole 91. The first outer peripheral surface 102 has a diameter that matches the diameter of the first inner peripheral surface 101. Accordingly, the first outer peripheral surface 102 is in surface contact with the first inner peripheral surface 101 when the first shaft 92 is inserted into the first hole 91. Accordingly, the first shaft 92 is fitted into the first hole 91 when the first shaft 92 is inserted into the first hole 91. The first lens block 17 and the second lens block 18 are positioned in the X-axis direction and the Y-axis direction perpendicular to the second optical axis 32 when the first shaft 92 is fitted into the first hole 91. This allows the optical center of the first lens group 12 and the optical center of the second lens group 13 to be aligned with high accuracy.

When the first shaft 92 is fitted into the first hole 91, the XY plane that forms part of the second face 82 contacts the XY plane that forms part of the first face 81. As a result, the first lens block 17 and the second lens block 18 are positioned in the Z-axis direction, which is parallel to the second optical axis 32, when the first shaft 92 is fitted into the first hole 91.

The first shaft 92 has a protruding shape extending in the Z-axis direction. The first hole 91 has a recessed shape extending in the Z-axis direction. Therefore, when the first shaft 92 is inserted into the first hole 91, the first shaft 92 and the first hole 91 are guided to approach each other in the Z-axis direction. The first shaft 92 is also referred to as a guide shaft and the first hole 91 is also referred to as a guide hole.

### 1.4 Positioning of Entire System in X-Axis, Y-Axis, and Z-Axis Directions

As illustrated in FIG. 2, the second lens block 18 and the imaging block 19 have a first facing face 111 and a second facing face 112, respectively, facing each other.

A rear-end side opening, which is the rear end of the second space 52, is formed in the center of the first facing face 111. A front-end side opening, which is the front end of a third space 53, is formed at the center of the second facing face 112. The rear-end side opening and the front-end side opening have a circular circumferential shape.

A second hole 121 is formed in one of the first facing face 111 and the second facing face 112. A second shaft 122 is formed in the other of the first facing face 111 and the second facing face 112. FIG. 2 illustrates the second hole 121 formed in the first facing face 111 and the second shaft 122 formed in the second facing face 112.

The second hole 121 has a second inner peripheral surface 131. The second inner peripheral surface 131 has a circumferential shape. When the second hole 121 is formed in the first facing face 111, the second inner peripheral surface 131 has a central axis that coincides with the optical center of the second lens group 13 and is coaxially aligned with the first hole 91 or the first shaft 92 formed in the second face 82. On the other hand, the second inner peripheral surface 131 has a central axis that coincides with a center of the imaging element 21 when the second hole 121 is formed in the second facing face 112. The second hole 121 is part of the second space 52 when the second hole 121 is formed in the first facing face 111. On the other hand, the second hole 121 is part of the third space 53 when the second hole 121 is formed in the second facing face 112.

The second shaft 122 has a second outer peripheral surface 132. The second outer peripheral surface 132 has a circumferential shape. The second outer peripheral surface 132 has a central axis that coincides with the center of the imaging element 21 when the second shaft 122 is formed in the second facing face 112. On the other hand, the second outer peripheral surface 132 has a central axis that coincides with the optical center of the second lens group 13 when the second shaft 122 is formed in the first facing face 111, and is coaxially disposed with the first hole 91 or the first shaft 92 formed in the first face 81. The second shaft 122 surrounds a portion of the third space 53 externally in the radial direction when the second shaft 122 is formed in the second facing face 112. On the other hand, the second shaft 122 surrounds a portion of the second space 52 externally in the radial direction when the second shaft 122 is formed in the first facing face 111.

The second shaft 122 is inserted into the second hole 121. The second outer peripheral surface 132 has a diameter that matches the diameter of the second inner peripheral surface 131. Accordingly, the second outer peripheral surface 132 is in surface contact with the second inner peripheral surface 131 when the second shaft 122 is inserted into the second hole 121. This allows the second shaft 122 to be fitted into the second hole 121 when the second shaft 122 is inserted into the second hole 121. The second lens block 18 and the imaging block 19 are positioned in the X-axis direction and the Y-axis direction perpendicular to the second optical axis 32 when the second shaft 122 is fitted into the second hole 121. This allows the optical center of the second lens group 13 and the center of the imaging element 21 to be aligned with high accuracy.

When the second shaft 122 is fitted into the second hole 121, the XY plane that forms part of the second facing face 112 contacts the XY plane that forms part of the first facing face 111. This allows the second lens block 18 and the imaging block 19 to be positioned in the Z-axis direction, which is parallel to the second optical axis 32, when the second shaft 122 is fitted into the second hole 121.

The second shaft 122 has a protruding shape extending in the Z-axis direction. The second hole 121 has a recessed shape extending in the Z-axis direction. Therefore, when the second shaft 122 is inserted into the second hole 121, the second shaft 122 and the second hole 121 are guided to approach each other in the Z-axis direction. The second shaft 122 is also referred to as a guide shaft and the second hole 121 is also referred to as a guide hole.

The reflection block 16 and the first lens block 17 have a third facing face 141 and a fourth facing face 142, respectively, facing each other.

A front-end side opening, which is the front end of the first space 51, is formed in the center of the fourth facing face 142. The front-end side opening has a circular circumferential shape.

A third hole 151 is formed in one of the third facing face 141 and the fourth facing face 142. A third shaft 152 is formed in the other of the third facing face 141 and the fourth facing face 142. FIG. 2 illustrates the third hole 151 formed in the third facing face 141 and the third shaft 152 formed in the fourth facing face 142.

The third hole 151 has a third inner peripheral surface 171. The third inner peripheral surface 171 has a circumferential shape. The third inner peripheral surface 171 has a central axis that coincides with a center of the reflection element 11 when the third hole 151 is formed in the third facing face 141. On the other hand, the third inner peripheral surface 171 has a central axis that coincides with the optical center of the first lens group 12 when the third hole 151 is formed in the fourth facing face 142, and is coaxially aligned with the first hole 91 or the first shaft 92 formed in the first face 81. The third hole 151 is part of the first space 51 when the third hole 151 is formed in the fourth facing face 142.

The third shaft 152 has a third outer peripheral surface 172. The third outer peripheral surface 172 has a circumferential shape. The third outer peripheral surface 172 has a central axis that coincides with the optical center of the first lens group 12 when the third shaft 152 is formed in the fourth facing face 142, and is coaxially aligned with the first hole 91 or the first shaft 92 formed in the first face 81. On the other hand, the third outer peripheral surface 172 has a central axis that coincides with the center of the reflection element 11 when the third shaft 152 is formed in the third facing face 141. The third shaft 152 surrounds a portion of the first space 51 externally in the radial direction when the third shaft 152 is formed in the fourth facing face 142.

The third shaft 152 is inserted into the third hole 151. The third outer peripheral surface 172 has a diameter that matches the diameter of the third inner peripheral surface 171. Accordingly, the third outer peripheral surface 172 is in surface contact with the third inner peripheral surface 171 when the third shaft 152 is inserted into the third hole 151. Accordingly, the third shaft 152 is fitted into the third hole 151. The reflection block 16 and the first lens block 17 are positioned in the X-axis direction and the Y-axis direction perpendicular to the second optical axis 32 when the third shaft 152 is fitted into the third hole 151. This allows the center of the reflection element 11 and the optical center of the first lens group 12 to be aligned with each other with high accuracy.

When the third shaft 152 is fitted into the third hole 151, the XY plane that forms part of the fourth facing face 142 contacts the XY plane that forms part of the third facing face 141. As a result, the reflection block 16 and the first lens block 17 are positioned in the Z-axis direction, which is parallel to the second optical axis 32, when the third shaft 152 is fitted into the third hole 151.

The third shaft 152 has a protruding shape extending in the Z-axis direction. The third hole 151 has a recessed shape extending in the Z-axis direction. Therefore, when the third shaft 152 is inserted into the third hole 151, the third shaft 152 and the third hole 151 are guided to approach each other in the Z-axis direction. The third shaft 152 is also referred to as a guide shaft and the third hole 151 is also referred to as a guide hole.

These allow the reflection block 16, the first lens block 17, the second lens block 18, and the imaging block 19 to be positioned in the X-axis, Y-axis, and Z-axis directions. This allows the center of the reflection element 11, the optical center of the first lens group 12, the optical center of the second lens group 13, and the center of the imaging element 21 to be aligned with high accuracy.

### 1.5 Positioning in Rotational Direction

FIG. 4 is a sectional view schematically illustrating a cross-section of the camera module according to the first embodiment at the position on line B-B depicted in FIG. 1.

As illustrated in FIG. 4, a first shaft hole 181 is formed in the first lens block 17. A second shaft hole 182 is formed in the second lens block 18. A third shaft hole 183 is formed in the imaging block 19. A fourth shaft hole 184 is formed in the reflection block 16.

Each of the first shaft hole 181, the second shaft hole 182, the third shaft hole 183, and the fourth shaft hole 184 extends in the Z-axis direction parallel to the second optical axis 32. The first shaft hole 181, the second shaft hole 182, the third shaft hole 183, and the fourth shaft hole 184 are aligned in the Z-axis direction. Accordingly, the first shaft hole 181, the second shaft hole 182, the third shaft hole 183, and the fourth shaft hole 184 constitute one continuous hole extending in the Z-axis direction.

The first shaft hole 181, second shaft hole 182, third shaft hole 183, and fourth shaft hole 184 are formed away from the second optical axis 32 and are disposed away from the optical center of the first lens group 12, the optical center of the second lens group 13, the center of the imaging element 21, and the center of the reflection element 11.

As illustrated in FIG. 4, the camera module 1 has a shaft 191. The shaft 191 is also referred to as a guide shaft.

The shaft 191 is disposed across the first shaft hole 181, the second shaft hole 182, the third shaft hole 183, and the fourth shaft hole 184. The shaft 191 is one continuous shaft. This allows the first lens block 17, the second lens block 18, the imaging block 19, and the reflection block 16 to be positioned in a rotational direction in which those blocks rotate about the second optical axis 32. This allows occurrence of vignette of light beams or the like due to misalignment in the rotational direction to be suppressed even when the top and bottom of the lens closest to the reflection element 11 and having the largest diameter is cut off to reduce its dimension in the height direction and the reflection surface of the reflection element 11 and the light receiving surface of the imaging element 21 have a rectangular shape.

### 1.6 Planar Alignment

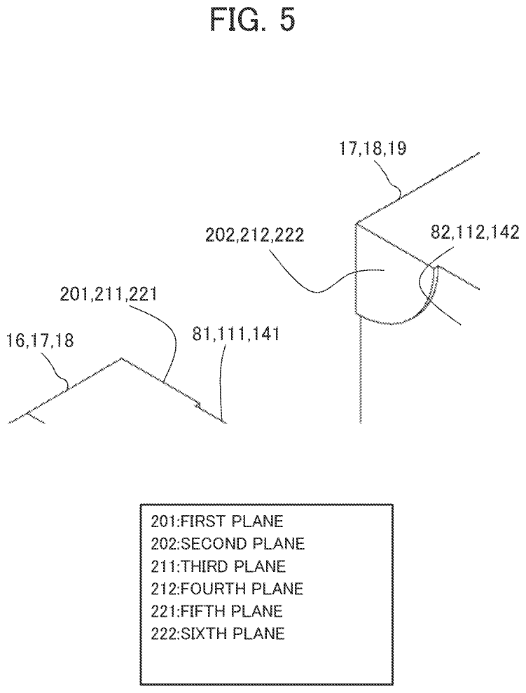

FIG. 5 is a perspective view schematically illustrating a pair of the first lens block and the second lens block, a pair of the second lens block and the imaging block, or a pair of the reflection block and the first lens block provided in the camera module of the first embodiment.

As illustrated in FIG. 5, the first face 81 of the first lens block 17 includes a first plane 201 that is part of the first face 81. When the first face 81 has a rectangular planar shape, the first plane 201 is disposed at four corners of the first face 81, for example. The first plane 201 protrudes from the remaining surface included in the first face 81.

The second face 82 of the second lens block 18 includes a second plane 202 that is part of the second face 82. When the second face 82 has a rectangular planar shape, the second plane 202 is disposed at four corners of the second face 82, for example. The second plane 202 protrudes from the remaining surface included in the second face 82.

The second plane 202 is in surface contact with the first plane 201. This aligns the first plane 201 and the second plane 202. This positions the first lens block 17 and the second lens block 18 in the Z-axis direction.

The accuracy of positioning of the first lens block 17 and the second lens block 18 is affected by the flatness of the first plane 201 and the flatness of the second plane 202, but is not affected by the flatness of the remaining surfaces included in the first face 81 and the second face 82. Therefore, to increase the accuracy of positioning, it is sufficient to increase the flatness of the first plane 201 and the flatness of the second plane 202 without increasing the flatness of the entire first face 81 and the flatness of the entire second face 82. This facilitates the working of the first lens block 17 and the second lens block 18.

Similarly, the first facing face 111 of the second lens block 18 includes a third plane 211 that is part of the first facing face 111. When the first facing face 111 has a rectangular planar shape, the third plane 211 is disposed at four corners of the first facing face 111, for example. The third plane 211 protrudes from the remaining surface included in the first facing face 111.

The second facing face 112 of the imaging block 19 includes a fourth plane 212 that is part of the second facing face 112. When the second facing face 112 has a rectangular planar shape, the fourth plane 212 is disposed at four corners of the second facing face 112, for example. The fourth plane 212 protrudes from the remaining surface included in the second facing face 112.

The fourth plane 212 is in surface contact with the third plane 211. This aligns the third plane 211 and the fourth plane 212. This positions the second lens block 18 and the imaging block 19 in the Z-axis direction.

Similarly, the third facing face 141 of the reflection block 16 includes a fifth plane 221 that is part of the third facing face 141. When the third facing face 141 has a rectangular planar shape, the fifth plane 221 is disposed at four corners of the third facing face 141, for example. The fifth plane 221 protrudes from the remaining surface included in the third facing face 141.

The fourth facing face 142 of the first lens block 17 includes a sixth plane 222 that is part of the fourth facing face 142. When the fourth facing face 142 has a rectangular planar shape, the sixth plane 222 is disposed at four corners of the fourth facing face 142, for example. The sixth plane 222 protrudes from the remaining surface included in the fourth facing face 142.

The sixth plane 222 is in surface contact with the fifth plane 221. This aligns the fifth plane 221 and the sixth plane 222. This positions the reflection block 16 and the first lens block 17 in the Z-axis direction.

### 1.7 Optical Camera Shake Correction

The camera module 1 includes a detection unit, a controller, and a drive mechanism for optical camera shake correction.

The detector detects the state of camera shake and outputs a signal corresponding to the detected state of camera shake. The detector is an angular rate sensor, an acceleration sensor, or the like.

The drive mechanism drives the second lens group 13 in the X-axis direction and the Y-axis direction perpendicular to the second optical axis 32. The drive mechanism is disposed between the second lens group 13 and the second lens block 18.

The controller controls the drive mechanism based on the output signal. The controller causes the drive mechanism to drive, based on the output signal, the second lens group 13 in the X-axis direction and the Y-axis direction perpendicular to the second optical axis 32 in order to perform optical camera shake correction.

The optical camera shake correction may be performed by driving elements other than the second lens group 13 in addition to or instead of driving the second lens group 13. For example, the optical camera shake correction may be performed by driving all or part of the reflection element 11, the optical system 71, and the imaging unit 15 in addition to driving the second lens group 13.

When the optical camera shake correction is performed by driving the reflection element 11, for example, the optical camera shake correction is performed by rotating the reflection element 11 using any two axes of rotation. In this case, the camera module 1 includes a drive mechanism and a holding member. The drive mechanism generates the driving force to rotate the reflection element 11. The holding member holds the reflection element 11 and transmits the generated driving force to the reflection element 11 to rotate the reflection element 11.

When the optical camera shake correction is performed by driving the optical system 71, for example, the optical camera shake correction is performed by moving the optical system 71 parallel to any two axes. In this case, the camera module 1 includes a drive mechanism and a holding member. The drive mechanism generates the driving force to move the optical system 71. The holding member holds the optical system 71 and transmits the generated driving force to the optical system 71 to move the optical system 71.

When the optical camera shake correction is performed by driving the imaging unit 15, for example, the optical camera shake correction is performed by moving the imaging unit 15 parallel to any two axes. In this case, the camera module 1 includes a drive mechanism and a holding member. The drive mechanism generates the driving force to move the imaging unit 15. The holding member holds the imaging unit 15 and transmits the generated driving force to the imaging unit 15 to move the imaging unit 15.

When any of the elements of the reflection element 11, the optical system 71, the imaging unit 15, and the second lens group 13 is driven, the optical camera shake correction is performed by moving the image of an object in the X-axis direction and the Y-axis direction perpendicular to the second optical axis 32 on the imaging plane of the optical system 71. Therefore, the optical camera shake correction can also be performed by rotating or moving respective elements in a plurality of drive directions that differ from each other. For example, the optical camera shake correction can be performed by rotating the reflection element 11 with one axis as the central axis and moving the second lens group 13 parallel to another axis.

### 2 Second Embodiment

In the following, points in which the second embodiment differs from the first embodiment will be described. For points not described, the same configuration as that employed in the first embodiment is also employed in the second embodiment.

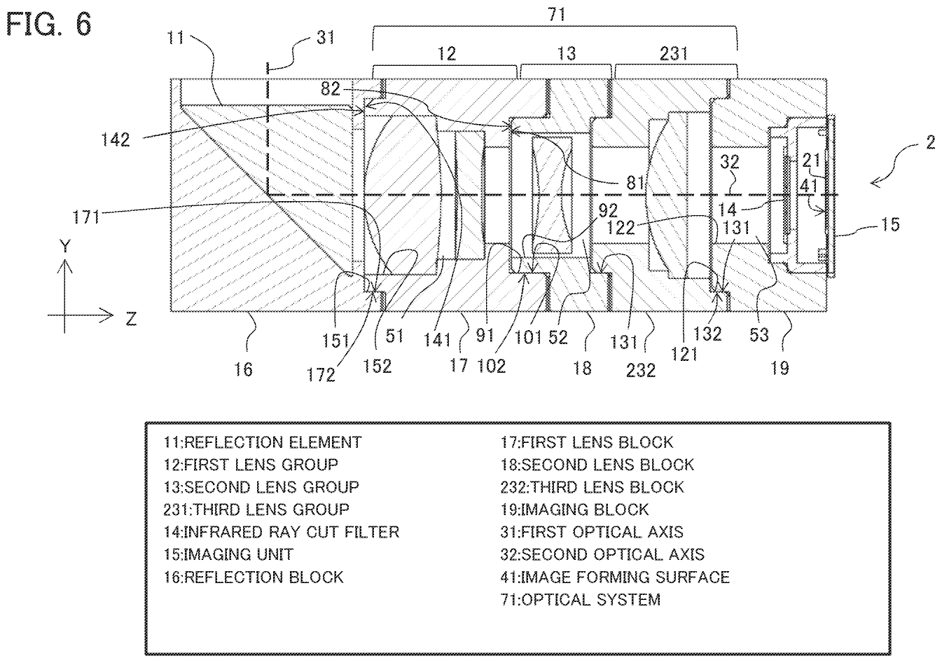

FIG. 6 is a sectional view schematically illustrating a cross-section of a camera module according to a second embodiment. FIG. 6 illustrates the cross-section obtained by cutting the center of the camera module of the second embodiment in the direction of the optical axis of the camera module.

The second embodiment of the camera module 2 illustrated in FIG. 6 has a third lens group 231 and a third lens block 232.

The first lens group 12 receives light traveling along the second optical axis 32 and transmits the received light. The first lens group 12 has one or more lenses. The first lens group 12 has a positive power as a whole.

The second lens group 13 is disposed at the rear of the first lens group 12. Therefore, the second lens group 13 receives light transmitted through the first lens group 12 and transmits the received light. The second lens group 13 has one or more lenses. The second lens group 13 has a negative power as a whole.

The third lens group 231 is disposed at the rear of the second lens group 13. Therefore, the third lens group 231 receives light transmitted through the second lens group 13, transmits the received light, and converges the transmitted light onto the image forming surface 41. The third lens group 231 has one or more lenses. The third lens group 231 has a positive power as a whole.

The first lens group 12, the second lens group 13, the third lens group 231, and the drive mechanism 62 constitute the optical system 71.

The third lens block 232 holds the third lens group 231. The third lens block 232 holds the third lens group 231 by holding the outer circumference of the third lens group 231.

The second lens block 18 and the third lens block 232 provided in the camera module 2 of the second embodiment are positioned in the same manner as the first lens block 17 and second lens block 18 provided in the camera module 1 of the first embodiment. The third lens block 232 and the imaging block 19 provided in the camera module 2 of the second embodiment are positioned in the same manner as the second lens block 18 and the imaging block 19 provided in the camera module 1 of the first embodiment.

### 3 Third Embodiment

In the following, points in which the third embodiment differs from the first embodiment will be described. For points not described, the same configuration as that employed in the first embodiment is also employed in the third embodiment.

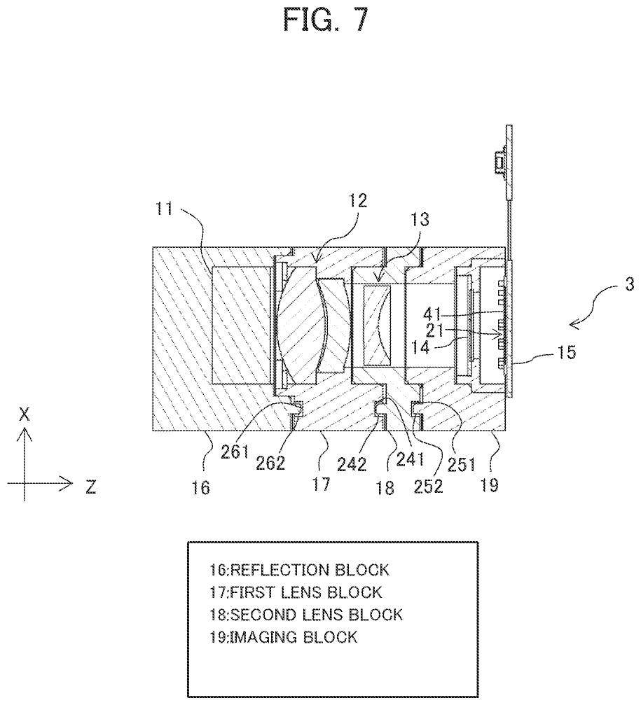

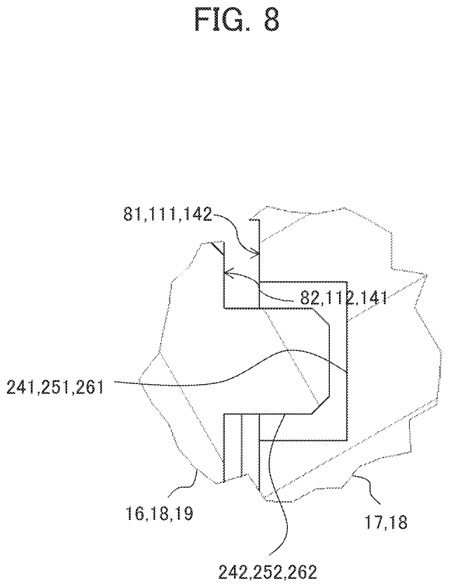

FIG. 7 is a sectional view schematically illustrating a cross-section of a camera module according to a third embodiment. FIG. 8 is a sectional view of the camera module according to the third embodiment, schematically illustrating a cross-section of the camera module in the vicinity of protrusions and recesses provided in the camera module.

As illustrated in FIGS. 7 and 8, in the camera module 3 of the third embodiment, a first recess 241 is formed in one of the first face 81 of the first lens block 17 and the second face 82 of the second lens block 18. A first protrusion 242 is formed on the other of the first face 81 of the first lens block 17 and the second face 82 of the second lens block 18. FIGS. 7 and 8 illustrate the state in which the first recess 241 is formed in the first face 81 and the first protrusion 242 is formed on the second face 82.

The first recess 241 and the first protrusion 242 extend in the Z-axis direction parallel to the second optical axis 32.

The first protrusion 242 is inserted into the first recess 241. The first recess 241 and the first protrusion 242 are positioned to allow the first protrusion 242 to be inserted into the first recess 241 without interference from other elements. The first recess 241 and the first protrusion 242 are formed away from the second optical axis 32 and are positioned away from the optical center of the first lens group 12, the optical center of the second lens group 13, the center of the imaging element 21, and the center of the reflection element 11. The first protrusion 242 is a boss, a pin, or the like. This allows the first lens block 17 and the second lens block 18 to be positioned in the rotational direction of rotation about the second optical axis 32.

Similarly, a second recess 251 is formed in one of the first facing face 111 of the second lens block 18 and the second facing face 112 of the imaging block 19. A second protrusion 252 is formed on the other of the first facing face 111 of the second lens block 18 and the second facing face 112 of the imaging block 19. FIGS. 7 and 8 illustrate the state in which the second recess 251 is formed in the first facing face 111 and the second protrusion 252 is formed on the second facing face 112.

The second recess 251 and the second protrusion 252 extend in the Z-axis direction parallel to the second optical axis 32.

The second protrusion 252 is inserted into the second recess 251. The second recess 251 and the second protrusion 252 are positioned to allow the second protrusion 252 to be inserted into the second recess 251 without interference from other elements. The second recess 251 and the second protrusion 252 are formed away from the second optical axis 32 and are positioned away from the optical center of the first lens group 12, the optical center of the second lens group 13, the center of the imaging element 21, and the center of the reflection element 11. The second protrusion 252 is a boss, a pin, or the like. This allows the second lens block 18 and the imaging block 19 to be positioned in the rotational direction of rotation about the second optical axis 32.

Similarly, a third recess 261 is formed in one of the third facing face 141 of the reflection block 16 and the fourth facing face 142 of the first lens block 17. A third protrusion 262 is formed on the other of the third facing face 141 of the reflection block 16 and the fourth facing face 142 of the first lens block 17. FIGS. 7 and 8 illustrate the state in which the third protrusion 262 is formed on the third facing face 141 and the third recess 261 is formed in the fourth facing face 142.

The third recess 261 and the third protrusion 262 extend in the Z-axis direction parallel to the second optical axis 32.

The third protrusion 262 is inserted into the third recess 261. The third recess 261 and the third protrusion 262 are positioned to allow the third protrusion 262 to be inserted into the third recess 261 without interference from other elements. The third recess 261 and the third protrusion 262 are formed away from the second optical axis 32 and are positioned away from the optical center of the first lens group 12, the optical center of the second lens group 13, the center of the imaging element 21, and the center of the reflection element 11. The third protrusion 262 is a boss, a pin, or the like. This allows the reflection block 16 and the first lens block 17 to be positioned in the rotational direction of rotation about the second optical axis 32.

These allow the optical system 71 to be assembled using only the first lens block 17 and second lens block 18. This allows for easy evaluation of the optical system 71.

It should be understood by those skilled in the art that various modifications, combinations, sub-combinations and alterations may occur depending on design requirements and other factors insofar as they are within the scope of the appended claims or the equivalents thereof.

What is claimed is:

1. A camera module, comprising:
a first lens group that transmits light;
a first lens block that holds the first lens group and has a first face;
a second lens group that transmits the light; and
a second lens block that holds the second lens group, has a drive mechanism to drive the second lens group in an optical axis direction, and has a second face opposite the first face, wherein
a first hole having a first inner peripheral surface having a circumferential shape is formed in one of the first face and the second face,
the first inner peripheral surface has a central axis that coincides with an optical center of the first lens group when the first hole is formed in the first face, and has a central axis that coincides with an optical center of the second lens group when the first hole is formed in the second face,
a first shaft having a first outer peripheral surface having a circumferential shape and being fitted into the first hole is formed in another of the first face and the second face, and
the first outer peripheral surface has a central axis that coincides with the optical center of the second lens group when the first shaft is formed in the second face, and has a central axis that coincides with the optical center of the first lens group when the first shaft is formed in the first face.

2. The camera module according to claim 1, wherein
the first face includes a first plane that is part of the first face, and
the second face includes a second plane that is part of the second face and is in surface contact with the first plane.

3. The camera module according to claim 1, wherein
a first recess is formed in one of the first face and the second face away from the optical center of the first lens group and the optical center of the second lens group, and
a first protrusion inserted into the first recess is formed on another of the first face and the second face.

4. The camera module according to claim 1, wherein
a first shaft hole is formed in the first lens block,
a second shaft hole is formed in the second lens block, and the camera module further comprises a shaft disposed across the first shaft hole and the second shaft hole.

5. The camera module according to claim 1, wherein
the second lens block has a first facing face,
the camera module further comprises
an imaging element capturing an image formed by the light and
an imaging block holding the imaging element and having a second facing face opposite the first facing face,
a second hole having a second inner peripheral surface having a circumferential shape is formed in one of the first facing face and the second facing face, and
a second shaft having a second outer peripheral surface having a circumferential shape and being fitted into the second hole is formed in another of the first facing face and the second facing face.

6. The camera module according to claim 5, wherein
the first facing face includes a third plane that is part of the first facing face, and
the second facing face includes a fourth plane that is part of the second facing face and is in surface contact with the third plane.

7. The camera module according to claim 5, wherein
a second recess is formed in one of the first facing face and the second facing face away from the optical center of the first lens group and the optical center of the second lens group, and
a second protrusion inserted into the second recess is formed on another of the first facing face and the second facing face.

8. The camera module according to claim 5, wherein
a first shaft hole is formed in the first lens block,
a second shaft hole is formed in the second lens block,
a third shaft hole is formed in the imaging block, and
the camera module further comprises a shaft disposed across the first shaft hole, the second shaft hole, and the third shaft hole.

9. The camera module according to claim 5, further comprising:
a reflection element that reflects the light; and
a reflection block holding the reflection element and having a third facing face, wherein
the first lens block has a fourth facing face opposite the third facing face, and
a third hole having a third inner peripheral surface having a circumferential shape is formed in one of the third facing face and the fourth facing face, and
a third shaft having a third outer peripheral surface having a circumferential shape and being fitted into the third hole is formed in another of the third facing face and the fourth facing face.

10. The camera module according to claim 9, wherein
the third facing face includes a fifth plane that is part of the third facing face, and
the fourth facing face includes a sixth plane that is part of the fourth facing face and is in surface contact with the fifth plane.

11. The camera module according to claim 9, wherein
a third recess is formed in one of the third facing face and the fourth facing face away from the optical center of the first lens group and the optical center of the second lens group, and
a third protrusion inserted into the third recess is formed in another of the third facing face and the fourth facing face.

12. The camera module according to claim 9, wherein
a first shaft hole is formed in the first lens block,
a second shaft hole is formed in the second lens block,
a third shaft hole is formed in the imaging block,
a fourth shaft hole is formed in the reflection block, and
the camera module further comprises a shaft disposed across the first shaft hole, the second shaft hole, the third shaft hole, and the fourth shaft hole.
